(19) United States
(12) Patent Application Publication
(10) Pub. No.: US 2025/0181294 A1
(43) Pub. Date: Jun. 5, 2025

(54) PROJECTION DEVICE, CONTROL METHOD OF PROJECTION DEVICE, AND PROJECTION SYSTEM

(71) Applicant: Coretronic Corporation, Hsin-Chu (TW)

(72) Inventors: Hsin-Ya Lai, Hsin-Chu (TW); Jung-Chi Chen, Hsin-Chu (TW)

(73) Assignee: Coretronic Corporation, Hsin-Chu (TW)

(21) Appl. No.: 18/967,481

(22) Filed: Dec. 3, 2024

(30) Foreign Application Priority Data
Dec. 5, 2023 (CN) 202311657388.8

(51) Int. Cl. G06F 3/14; G06F 16/51; G06F 16/538; G06T 11/00; G06V 10/70; G10L 15/22; G10L 25/51

(52) U.S. Cl. CPC G06F 3/14; G06F 16/51; G06F 16/538; G06T 11/00; G06V 10/70; G10L 15/22; G10L 25/51

(57) ABSTRACT

A projection device, control method of projection device, and projection system are provided. An environment sensing module of the projection device is configured to sense a surrounding environment of the projection device to obtain sensing result. A processor of the projection device is configured to execute: determining a target theme corresponding to the surrounding environment according to the sensing result, and searching a target picture database that matches the target theme from a plurality of picture databases; selecting at least one target picture from the target picture database in response to searching out the target picture database from the plurality of picture databases; generating the at least one target picture according to the target theme in response to not searching out the target picture database from the plurality of picture databases; and enabling the projection device to project a projection image having the at least one target picture.

### CROSS-REFERENCE TO RELATED APPLICATION

This application claims the priority benefit of China application serial no. 202311657388.8, filed on Dec. 5, 2023. The entirety of the above-mentioned patent application is hereby incorporated by reference herein and made a part of this specification.

### BACKGROUND

### Technical Field

The disclosure relates to a projection system, and more particularly, to a projection device, a control method of the projection device and a projection system.

### Description of Related Art

Most of system-setting images used in a current projection device (projector) are generated by camera shooting or manual drawing. These methods limit a diversity of the images, and the current projection device also lack the adaptive adjustment of the system-setting images according to the detected characteristics of a surrounding environment of the projection device.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a projection system, a projection device and a control method thereof, which may search or generate corresponding target pictures for projection based on sensing result of a surrounding environment.

Additional aspects and advantages of the disclosure will be set forth in the description of the techniques disclosed in the disclosure.

In order to achieve one or a portion of or all of the objects or other objects, an embodiment of the disclosure provides a projection device including an environment sensing module, a storage circuit unit and a processor. The environment sensing module is configured to sense a surrounding environment of the projection device to obtain sensing result. The storage circuit unit is configured to store a plurality of picture databases. The processor is coupled to the storage circuit unit and the environment sensing module. The processor is configured to execute: determining a target theme corresponding to the surrounding environment according to the sensing result of the environment sensing module, and searching a target picture database that matches the target theme from the plurality of picture databases; selecting at least one target picture from the target picture database in response to searching out the target picture database from the plurality of picture databases; generating the at least one target picture according to the target theme in response to not searching out the target picture database from the plurality of picture databases; and enabling the projection device to project a projection image having the at least one target picture.

Another embodiment of the disclosure provides a control method of a projection device. The projection device includes an environment sensing module and a processor. The method includes following steps: sensing a surrounding environment of the projection device by the environment sensing module to obtain sensing result; determining a target theme corresponding to the surrounding environment by the processor according to the sensing result; searching a target picture database that matches the target theme from a plurality of picture databases by the processor; selecting at least one target picture from the target picture database by the processor in response to searching out the target picture database from the plurality of picture databases; generating the at least one target picture by the processor according to the target theme in response to not searching out the target picture database from the plurality of picture databases; and projecting a projection image having the at least one target picture by the projection device.

Another embodiment of the disclosure provides a projection system including an environment sensing device, a projection device, a plurality of picture databases, and an artificial intelligence model. The environment sensing device is configured to sense a surrounding environment of the projection device to obtain sensing result. The artificial intelligence model is coupled to the environment sensing device and the plurality of picture databases. The artificial intelligence model is configured to determine a target theme corresponding to the surrounding environment according to the sensing result, and search a target picture database that matches the target theme from the plurality of picture databases. The artificial intelligence model selects at least one target picture from the target picture database in response to searching out the target picture database from the plurality of picture databases. The artificial intelligence model generates the at least one target picture according to the target theme in response to not searching out the target picture database from the plurality of picture databases. The projection device is coupled to the artificial intelligence model, and the projection device is configured to project a projection image having the at least one target picture.

In summary, embodiments of the disclosure provide a projection device, a control method of the projection device, and a projection system, which are adapted to intelligently determine a target theme corresponding to a surrounding environment according to sensing result of the surrounding environment of the projection device, search or generate a target picture that matches the target theme, and enable the projection device to project a projection image having the target picture.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A is a schematic diagram of a projection device according to an embodiment of the disclosure.

FIG. 1B is a schematic diagram of a projection system according to an embodiment of the disclosure.

FIG. 2 is a flowchart of a control method of a projection device according to an embodiment of the disclosure.

FIG. 3 is an operation flowchart of a projection system according to an embodiment of the disclosure.

FIG. 4 is a schematic diagram of a projection device projecting a target image according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “left,” “right,” “front,” “back,” etc., is used with reference to the orientation of the Figure(s) being described and are not intended to be limiting of the disclosure.

It is to be understood that other embodiment may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

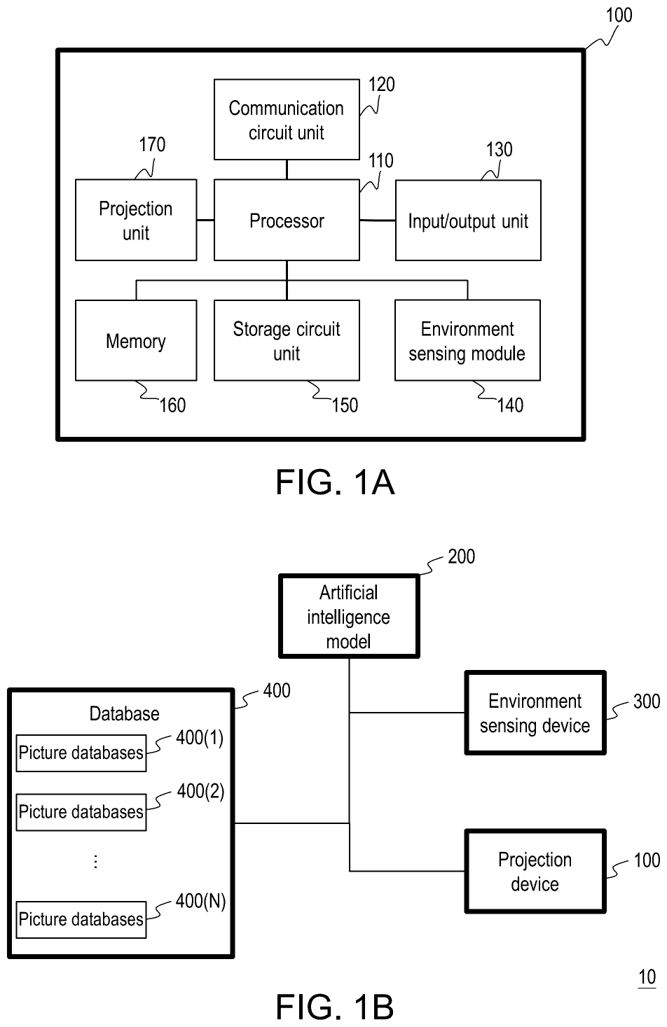

Referring to FIG. 1A, FIG. 1A is a schematic diagram of a projection device according to an embodiment of the disclosure. In the embodiment, a projection device 100 (also known as a projector) includes a processor 110, a communication circuit unit 120, an input/output unit 130, an environment sensing module 140, a storage circuit unit 150, a memory 160 and a projection unit. 170. The processor 110 is electrically connected (coupled) to the communication circuit unit 120, the input/output unit 130, the environment sensing module 140, the storage circuit unit 150, the memory 160 and the projection unit 170, and the processor 110 is configured to control and manage an overall operation of the projection device 100.

The processor 110 is, for example, a graphics processing unit (GPU), a microprogrammed control unit), a central processing unit (CPU), a programmable microprocessor, application specific integrated circuits (ASIC), a programmable logic device (PLD) or other similar devices.

The communication circuit unit 120 is configured to transmit or receive data through wired or wireless communication. In the embodiment, the communication circuit unit may have a wireless communication circuit or chip and support one of a global system for mobile communication (GSM) system, a wireless fidelity (WiFi) system, and Bluetooth communication technology or a combination thereof, but the disclosure is not limited thereto.

The input/output unit 130 includes input devices and output devices. The input devices include, for example, a touch pad, a touch panel, a knob, a remote controller, keys, etc., which allow a user to input data or operate instructions. The output devices are, for example, a monitor, a speaker, a loudspeaker, etc., but the disclosure is not limited thereto. The display is, for example, a liquid crystal display (LCD), a light-emitting diode (LED) display, or an organic light-emitting diode (OLED) display. In an embodiment, the input/output unit 130 may include, for example, a touch screen for displaying various information and system interfaces of the projection device 100 and receiving user input data or operation instructions.

The environment sensing module 140 includes a sound receiving device and/or an image capturing device (not shown). The sound receiving device is, for example, a microphone, which is configured to sense sounds of a surrounding environment to generate sound data. The image capturing device is, for example, a video camera or a camera, etc., that uses a charge coupled device (CCD) lens or a complementary metal oxide semiconductor transistors (CMOS) lens. The image capturing device is used to capture images of the surrounding environment to generate image data.

The storage circuit unit 150 may store data via instructions from the processor 110. The storage circuit unit 150 may include any type of a hard disk drive (HDD) or a non-volatile memory storage device (for example, SSD or flash memory). The storage circuit unit 150 is used to store a plurality of picture databases and personalized databases. In an embodiment, the storage circuit unit 150 may be used to store an artificial intelligence model, or the storage circuit unit 150 includes one or a plurality of program instructions, which may be executed by the processor 110 after being installed.

The memory 160 is configured to temporarily store instructions or data executed by the processor 110, and is, for example, a dynamic random access memory (DRAM), a static random access memory (SRAM), etc.

The projection unit 170 is configured to generate an image beam according to an instruction of the processor 110 to form a projection image. The projection unit 170 may include, for example, an optical module, a light valve, and a projection lens. The optical module is used to provide an illumination beam. The optical module includes at least one light source and optical elements. The light source may be at least one light emitting diode (LED), at least one laser diode (LD), or a combination thereof. The optical elements may include a wavelength conversion element, a light uniformizing element, a filter element, a light guide element and other elements. The light valve is disposed on a transmission path of the illumination beam to convert the illumination beam into an image beam. The light valve is, for example, a reflective light modulator such as a liquid crystal on silicon panel (LCoS panel), a digital micro-mirror device (DMD), etc. The light valve may also be a transparent liquid crystal panel, an electro-optical modulator, a magneto-optic modulator, an acousto-optic modulator (AOM) and other transmission optical modulators. The projection lens includes, for example, a combination of one or more optical lenses with diopter, such as various combinations of non-planar lenses including a biconcave lens, a biconvex lens, a concavo-convex lens, a convexo-concave lens, a plano-convex lens, a plano-concave lens, etc. In an embodiment, the projection lens may also include planar optical lenses. The projection lens is disposed on a transmission path of the image beam to project the image beam to the outside of the projection device 100.

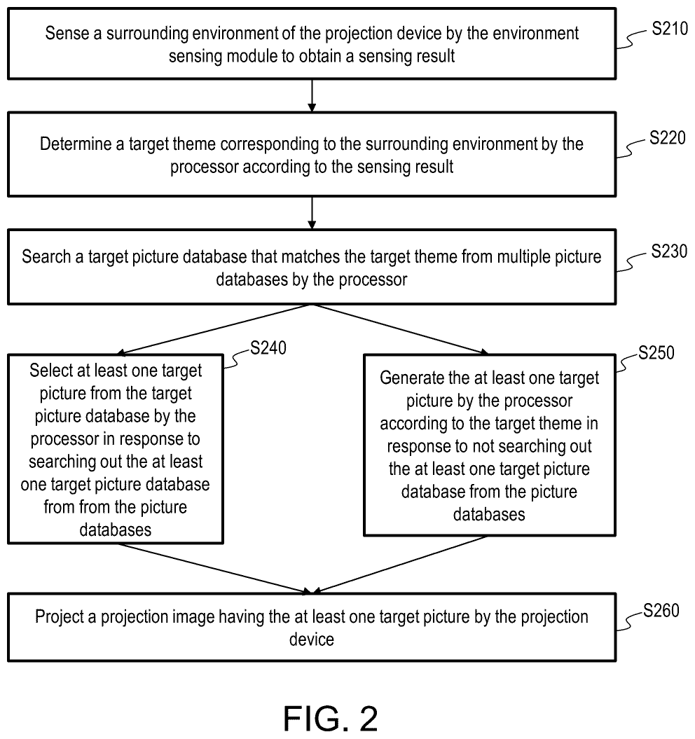

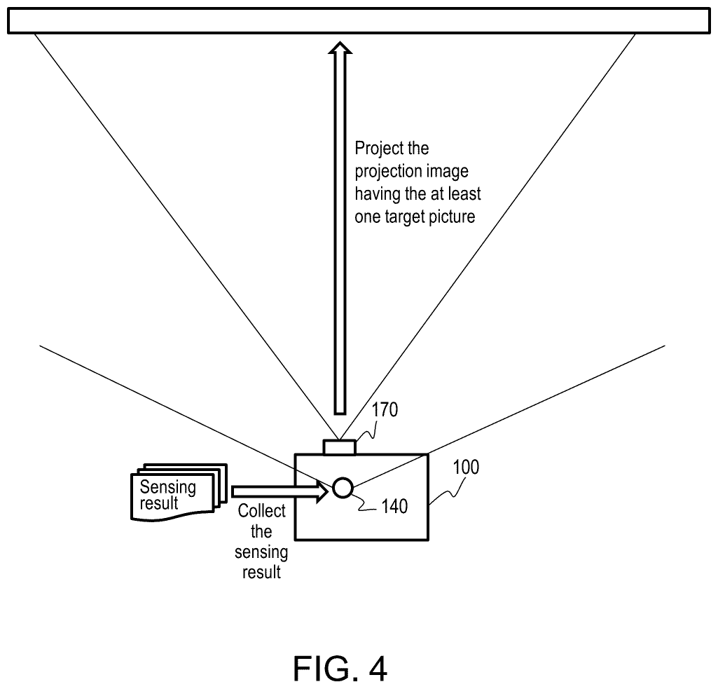

Referring to FIG. 2 and FIG. 4, FIG. 2 is a flowchart of a control method of a projection device according to an embodiment of the disclosure. FIG. 4 is a schematic diagram of a projection device projecting a target picture according to an embodiment of the disclosure. In step S210, a surrounding environment of the projection device 100 is sensed by the environment sensing module 140 to obtain sensing result. For example, when the projection device 100 is started, performs a specific operation, or in every other period of time, the environment sensing module 140 automatically senses the surrounding environment of the projection device 100.

In step S220, the processor 110 determines a target theme corresponding to the surrounding environment according to the sensing result. In the embodiment, the sensing result includes at least one of image data and sound data.

For example, the sensing result includes image data. The image capturing device (such as a camera) of the environment sensing module 140 is configured to capture images of the surrounding environment to generate image data. The processor 110 is used to identify objects in the image data and determine the target theme corresponding to the surrounding environment based on the objects. For example, when the objects in the image data include a dining table, chairs, tableware, etc., the processor 110 may determine that they conform to the target theme of “kitchen”; when the objects in the image data include office desks, documents, stationery, computers, etc., the processor 110 may determine that they conform to the target theme of “office”.

For another example, the sensing result includes sound data. The sound receiving device (such as a microphone) of the environment sensing module 140 receives sounds from the surrounding environment to generate the sound data. The processor 110 is used to analyze the received sound data to determine at least one sound source type corresponding to the sound data, and determine the target theme corresponding to the surrounding environment according to the at least sound source type. The sound source type includes, for example, noisy sounds in a conference room, happy sounds in a family, children's laughter, etc. In an embodiment, the sound data includes a user's voice instruction, and the user's voice instruction may include text content, and the processor 110 is configured to determine the corresponding target theme according to a keyword of the user's voice instruction. For example, the user may directly say a voice instruction of “please set the theme to A”, where A is a name of the target theme that the user wants to set, and the target theme is, for example, a family mode, an office mode, etc. In an embodiment, the user's voice instruction may also be used to set a target style. In an embodiment, the user may also directly instruct the processor 110 to generate a new target picture that conforms to the specified target theme through the user's voice instruction. For example, the user's voice instruction is “I want a Taipei 101 landscape painting in a style of Van Gogh.” The processor 110 may generate a corresponding picture according to text content of the user's voice instruction. In an embodiment, the processor 110, for example, first analyzes the user's voice instruction and then analyzes other background sound of the sound data.

In step S230, the processor 110 searches a target picture database that matches the target theme from a plurality of picture databases. The target theme may be, for example, a place of the surrounding environment of the projection device 100. The target theme is, for example: “office”, “conference room”, “lecture hall”, “classroom”, “outdoor”, “home”, “living room”, “movie hall”, etc. In another embodiment, the processor 110 determines the target style corresponding to the surrounding environment according to a combination of objects and colors in the sensing result, and searches the target picture database according to the target theme and the target style. The target style is, for example: “modern”, “Japanese style”, “European style”, “realistic”, “serious”, “lively”, “cold colors”, “bright”, “warm colors”, etc. In addition to being classified according to the target theme, the picture databases may also be classified according to the target theme and the target style at the same time (each target theme may have multiple different target styles), for example, an “office-serious” picture database, an “office-warm color” picture database, etc.

In step S240, in response to searching out the target picture database from the plurality of picture databases, the processor 110 selects at least one target picture from the target picture database.

In step S250, in response to not searching out the target picture database from the plurality of picture databases, the processor 110 generates the at least one target picture according to the target theme. In an embodiment, after generating the at least one target picture, the processor 110 is configured to store the at least one target picture into the storage circuit unit 150. For example, the at least one target picture may be stored in a new picture database corresponding to the target theme (and target style).

In an embodiment, the processor 110 generates a prompt according to the target theme, and selects or generates the at least one target picture according to the prompt. For example, it is assumed that the target theme is “office”, the corresponding generated prompt is, for example, “please select or generate an atmosphere picture with a target theme of an office”. For another example, it is assumed that the target theme is “office-warm color”, the corresponding prompt is, for example, “please select or generate an atmosphere picture with a target theme of an office, and a style of the atmosphere picture is a warm color”. The atmosphere picture is, for example, a picture that may increase an overall aesthetics of a space where the projection device 100 is located. Then, the processor 110 may input the generated prompt to the artificial intelligence model to generate the at least one target picture. The artificial intelligence model may be set up in the projection device 100 and executed by the processor 110, or the artificial intelligence model may be set up in a cloud server, and the processor 110 accesses the artificial intelligence model located in the cloud server through an application programming interface (API) for artificial intelligence picture generation to implement a picture generation function, so as to obtain the at least one target picture generated by the artificial intelligence model.

In another embodiment, the processor 110 may also access the artificial intelligence model located in the cloud server through an application programming interface (API) for prompt generation, so as to obtain the prompt matching the target theme and target style and generated by the artificial intelligence model.

In step S260, the projection device 100 projects a projection image having the at least one target picture. For example, the projection unit 170 of the projection device 100 projects the projection image having the at least one target picture.

In an embodiment, the processor 110 is also configured to set a system setting of the projection device 100, for example, set the at least one target picture as at least one of a desktop, a standby screen, and an icon of an application of the projection device 100.

In an embodiment, the processor 110 may use at least a pattern or a part of the target picture to generate the icon of the application. In another embodiment, the processor 110 may generate the icon of the application of the projection device 100 according to the target theme and/or the target style. In this way, the projection image having the icon of the application displayed on a projection screen of the projection device 100 may be consistent with the target theme and correspond to the surrounding environment. In an embodiment, the desktop of the projection device 100 and the icon of the application may be the same or similar target pictures generated based on the same target theme, so that the desktop of the projection device 100 has a unified look and feel.

In an embodiment, when the projection device 100 is idle for a predetermined period of time, for example, the projection device 100 is not connected to an image source, or the projection device 100 does not receive an image signal within a predetermined period of time, the processor 110 may use the sensing result of the surrounding environment to make the projection unit 170 to project the projection image having the target picture to serve as a standby image to execute a full-screen screen saver, thus achieving an effect of a decorative artwork.

In an embodiment, the processor 110 may periodically switch the projected target pictures. For example, the processor 110 may regularly project the target pictures of the same target theme and/or target style.

In an embodiment, the processor 110 may execute and project or display an image to ask the user about his/her feeling (also known as a user evaluation) about the target picture. The user may accordingly input his/her feeling about the target picture through the input/output unit 130 or may directly feedback whether he likes or dislikes the target picture. The processor 110 may record the above user evaluation in metadata of the corresponding target picture.

For example, the processor 110 may project an image through the projection unit 170 or display a display image through a display element of the input/output unit 130, where the display image includes the target picture and questions related to the target picture, for example, “do you like this target picture?”, “please enter the adjustments you would like to make to this target picture in the field below,” or “enter your feelings about this target picture in the field below”. Then, the processor 110 may obtain the user evaluation through an input operation of the user to the input/output unit 130. In an embodiment, the processor 110 may output a sound message through a speaker of the input/output unit 130 to ask the user questions related to the target picture in a voice manner. The user may also respond through a microphone of the input/output unit 130 to provide a feedback on the question. In other words, the input of the user evaluation may be implemented by typing specific messages/text, clicking specific buttons, or by voice input.

In an embodiment, the processor 110 may generate the prompt according to the user evaluation. For example, it is assumed that the target theme and the target style of the original target picture are “office-warm color”, and the user evaluation is “I hope it may be changed to a watercolor style picture”. The processor 110 may generate the prompt of “please select or generate an office-themed atmosphere picture based on the user evaluation, the style of the atmosphere picture is warm colors and drawn in a watercolor style”, and the processor 110 may obtain a new target picture according to the prompt.

In an embodiment, the processor 110 takes the target picture with the user evaluation as an evaluated picture and stores the same in the personalized database of the storage circuit unit 150. In this way, the processor 110 may infer the user's preferences based on the evaluated picture, so as to select or generate the target picture that is closer to the user's preferences. In an embodiment, the personalized database stores, for example, favorite target pictures of the user, and the user may quickly search or browse the favorite target pictures.

The processor 110 may identify at least one of a characteristic parameter and the prompt of the evaluated picture, and select or generate the at least one target picture according to at least one of the characteristic parameter and the prompt.

In an embodiment, in the plurality of evaluated pictures, the processor 110 may identify a plurality of first evaluated pictures that are evaluated as likes and characteristic parameters and/or the prompts of the plurality of first evaluated pictures. The processor 110 may also identify a plurality of second evaluated pictures that are evaluated as disliked and characteristic parameters and/or prompts of the plurality of second evaluated pictures.

For example, when the processor 110 identifies that most of the first evaluated pictures are target pictures with characteristics of small animals, the processor 110 may infer that the user likes pictures containing small animals, and generate a corresponding (positive) prompt. For another example, when the processor 110 identifies that the characteristic parameters (such as picture contrasts) of the plurality of first evaluated pictures are mostly higher than a specific value, the processor 110 may infer that the user likes pictures with the characteristic parameters (such as picture contrasts) being higher than the specific value. For another example, when the processor 110 identifies that the prompts corresponding to the plurality of first evaluated pictures have a word “watercolor”, the processor 110 may infer that the picture style that the user likes is the watercolor style.

When the processor 110 identifies that most of the plurality of second evaluated pictures are the target pictures with characteristics of plants, the processor 110 may infer that the user does not like pictures containing plants, and generate a corresponding (negative) prompt. For another example, when the processor 110 identifies that the characteristic parameters (such as picture brightness) of the plurality of second evaluated pictures are mostly lower than a specific value, the processor 110 may infer that the user does not like pictures with the characteristic parameters (such as picture brightness) lower than the specific value. For another example, when the processor 110 identifies that the prompts of the plurality of second evaluated pictures have a word “cartoon”, the processor 110 may infer that the style of the pictures that the user dislikes is the cartoon style.

In one embodiment, the processor 110 applies the inferred user likes and dislikes in the subsequent selection operation of the target picture. For example, it is assumed that the processor 110 identifies that the user prefers pictures with a contrast higher than a specific value, the processor 110 may select a picture with the contrast higher than the specific value from the target picture database as the target picture. For another example, it is assumed that the processor 110 identifies that the user dislikes pictures with a brightness lower than a specific value, the processor 110 may avoid selecting a picture with the brightness lower than the specific value from the target picture database as the target picture.

In an embodiment, the processor 110 applies the inferred user likes and dislikes in the subsequent generation operation of the target picture. For example, it is assumed that the processor 110 identifies that the user prefers watercolor style pictures, the prompt used by the processor 110 to generate the target picture may use a positive definition to generate a watercolor style picture. For example, the prompt may be “please generate an office-themed atmosphere picture and use a watercolor style”. For another example, it is assumed that the processor 110 identifies that the user is less fond of a cartoon style pictures, the prompt used by the processor 110 to generate the target picture may use the negative definition to avoid generating cartoon style pictures. For example, the prompt may be “please generate office-themed atmosphere picture, and avoid using the cartoon style”.

Referring to FIG. 1B, FIG. 1B is a schematic diagram of a projection system according to an embodiment of the disclosure. In the embodiment, the projection system 10 includes a projection device 100, an artificial intelligence model 200, an environment sensing device 300, and a database 400. The artificial intelligence model 200 is coupled to the projection device 100, the environment sensing device 300 and the database 400. The database 400 includes a plurality of picture databases 400(1)-400(N). In an embodiment, the projection system 10 further includes a cloud server (not shown).

The artificial intelligence model 200 may be disposed in the projection device 100 and executed by the processor 110 of the projection device 100, or may be installed in a cloud server and executed by a processor of the cloud server. The database 400 may be stored in the storage circuit unit 150 of the projection device 100 or in a cloud server. The environment sensing device 300 may be disposed in the projection device 100. For example, the environment sensing device 300 is a camera of the projection device 100. The environment sensing device 300 may also be disposed outside the projection device 100. The environment sensing device 300 may be directly connected to the artificial intelligence model 200 to directly transmit sensing result. For example, the environment sensing device 300 is connected to a smartphone or a camera/microphone with the artificial intelligence model 200. The smartphone may be used to capture images of the surrounding environment of the projection device 100 and transmit the same to the artificial intelligence model 200. The environment sensing device 300 may also be coupled to the projection device 100. After the environment sensing device 300 transmits the sensing result to the projection device 100, the projection device 100 transmits the sensing result to the artificial intelligence model 200. The artificial intelligence model 200 may be used to determine a target theme corresponding to the surrounding environment of the projection device 100 according to the sensing result, and search a target picture database that matches the target theme from the plurality of piture databases 400(1)-400(N). In response to searching out the target picture database from the plurality of picture databases 400(1)-400(N), the artificial intelligence model 200 selects at least one target picture from the target picture database. In response to not searching out the target picture database from the plurality of picture databases 400(1)-400(N), the artificial intelligence model 200 generates the at least one target picture according to the target theme. The projection device 100 is coupled to the artificial intelligence model 200, and the projection unit 170 of the projection device 100 is configured to project a projection image having the at least one target picture.

In the embodiment, the artificial intelligence model 200 may be used to perform operations such as identifying sensing result, selecting or generating the target picture, generating the prompt, etc., that may be performed by the processor 110 in FIG. 1A and FIG. 2. The artificial intelligence model 200 includes, for example, a chatbot with a machine learning algorithm and a picture generator. The chatbot is, for example, any pre-trained chatbot such as Chat Generative Pre-trained Transformer (ChatGPT), Microsoft Bing, Google Bard, or ERNIE Bot, etc., or may be a dedicated chatbot trained by a domain-specific material. The picture generator may be, for example, any one of pre-trained picture generators such as Jasper Art, Midjourney, DALL-E 2, DALL-E 3, Stability AI DreamStudio, Wombo Art, Stable Diffusion, etc. The target picture generated by the picture generator may be stored in the projection device 100 or the database 400 in the cloud server for the chatbot of the artificial intelligence model 200 to select the target picture. The above chatbot and picture generator may be respectively installed in the projection device 100 or the cloud server.

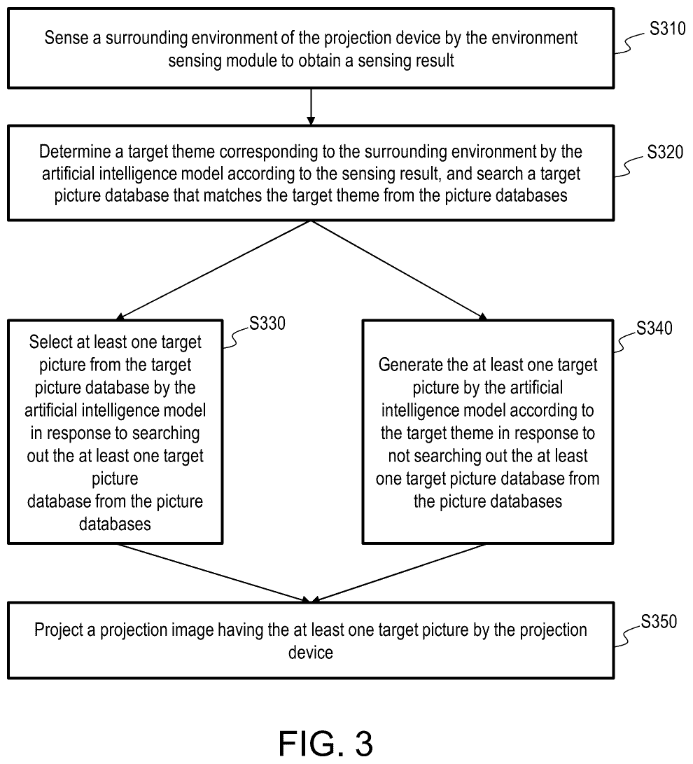

Referring to FIG. 3, FIG. 3 is an operation flowchart of a projection system according to an embodiment of the disclosure. In step S310, the environment sensing device 300 senses the surrounding environment of the projection device 100 to obtain sensing result. The environment sensing device 300 of the embodiment may perform the aforementioned operations that the environment sensing module 140 of FIG. 1A and FIG. 2 may perform. In step S320, the artificial intelligence model 200 determines the target theme corresponding to the surrounding environment according to the sensing result, and searches a target picture database that matches the target theme from the plurality of picture databases 400(1)-400(N). Specifically, the chatbot of the artificial intelligence model 200 may analyze the sensing result to determine the target theme and search the target picture database.

In step S330, in response to searching out the target image database from the plurality of picture databases 400(1)-400(N), the artificial intelligence model 200 selects at least one target picture from the target picture database. Specifically, the chatbot of the artificial intelligence model 200 may select the at least one target picture from the target picture database. In an embodiment, the chatbot also selects the target picture based on prompts and/or characteristic parameters.

In step S340, in response to not searching out the target picture database from the plurality of picture databases 400(1)-400(N), the artificial intelligence model 200 generates the at least one target picture according to the target theme. Specifically, the picture generator of the artificial intelligence model 200 generates the target picture according to the target theme. In an embodiment, the picture generator may further generate the target picture according to prompts and/or characteristic parameters.

In step S350, the projection device 100 projects the projection image having the at least one target picture.

In an embodiment, the user may also provide feedback on the target picture being projected at any time. For example, the input/output unit 130 of the projection device 100 is used to provide an evaluation option for each projected target picture, for example, a “like/dislike” button may be displayed at a corner or edge of the target picture so that the user may, for example, click the button of the input/output unit 130 to perform instant feedback on the target picture.

In summary, the embodiments of the disclosure provide a projection device, a control method of the projection device, and a projection system, which are adapted to intelligently determine the target theme corresponding to the surrounding environment according to the sensing result of the surrounding environment of the projection device, search or generate the target picture that matches the target theme, and set it as at least one of a desktop, a standby screen, and an icon of the application of the projection device for projection.

The embodiments of the disclosure have many advantages, including but not limited to the following three points: (1) through the sensing result corresponding to the surrounding environment, the target picture that is close to the atmosphere of the surrounding environment may be generated and the projection image having the target picture is projected, thereby enhancing the overall environment atmosphere. (2) The projected target picture has characteristics that adapt to the user's preferences, providing a more personalized user experience. (3) By applying the artificial intelligence model, non-repetitive target pictures may be generated to provide users with more diverse visual enjoyment. Overall, the projection device and the related control method and system of the disclosure provide users with a more intelligent, personalized and diversified projection experience, effectively combine the projection technology with the surrounding environment, and bring a richer visual experience for the users.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A projection device, comprising:
an environment sensing module configured to sense a surrounding environment of the projection device to obtain a sensing result;
a storage circuit unit configured to store a plurality of picture databases; and
a processor coupled to the storage circuit unit and the environment sensing module, wherein the processor is configured to execute:
determining a target theme corresponding to the surrounding environment according to the sensing result of the environment sensing module, and searching a target picture database that matches the target theme from the plurality of picture databases;
selecting at least one target picture from the target picture database in response to searching out the target picture database from the plurality of picture databases;
generating the at least one target picture according to the target theme in response to not searching out the target picture database from the plurality of picture databases; and
enabling the projection device to project a projection image having the at least one target picture.

2. The projection device according to claim 1, wherein the processor is further configured to execute:
determining a target style corresponding to the surrounding environment according to the sensing result, and searching the target picture database according to the target theme and the target style.

3. The projection device according to claim 1, wherein after the processor generates the at least one target picture, the processor is configured to store the at least one target picture into the storage circuit unit.

4. The projection device according to claim 1, wherein the processor is further configured to execute:
generating a prompt according to the target theme, and selecting or generating the at least one target picture according to the prompt.

5. The projection device according to claim 1, wherein the environment sensing module comprises a sound receiving device to receive sounds from the surrounding environment to generate sound data, wherein the sensing result comprises the sound data, and the processor is configured to analyze the sound data to determine at least one sound source type corresponding to the sound data, and determine the target theme corresponding to the surrounding environment according to the at least one sound source type.

6. The projection device according to claim 5, wherein the sound data comprises a user's voice instruction, and the processor is configured to determine the corresponding target theme according to the user's voice instruction.

7. The projection device according to claim 1, wherein the environment sensing module comprises an image capturing device to capture the surrounding environment to generate image data, wherein the sensing result comprises the image data, and the processor is configured to identify an object in the image data, and determine the target theme corresponding to the surrounding environment according to the object.

8. The projection device according to claim 1, wherein the processor is further configured to execute:
setting a system setting of the projection device, and setting the at least one target picture as at least one of a desktop, a standby screen, and an icon of an application of the projection device.

9. The projection device according to claim 1, wherein the projection device further comprises an input/output unit coupled to the processor, wherein the processor is further configured to execute:
receiving and recording a user evaluation from the input/output unit, and generating a prompt of the at least one target picture according to the user evaluation.

10. The projection device according to claim 9, wherein the storage circuit unit is configured to store a personalized database, the personalized database comprises at least one evaluated picture, and the at least one evaluated picture is the at least one target picture with the user evaluation,
wherein the processor is further configured to execute:
identifying at least one of a characteristic parameter and prompt of the evaluated picture; and
selecting or generating the at least one target picture according to at least one of the characteristic parameter and the prompt.

11. A control method of a projection device, wherein the projection device comprises an environment sensing module and a processor, and the control method comprises following steps:
sensing a surrounding environment of the projection device by the environment sensing module to obtain a sensing result;
determining a target theme corresponding to the surrounding environment by the processor according to the sensing result;
searching a target picture database that matches the target theme from a plurality of picture databases by the processor;
selecting at least one target picture from the target picture database by the processor in response to searching out the target picture database from the plurality of picture databases;
generating the at least one target picture by the processor according to the target theme in response to not searching out the target picture database from the plurality of picture databases; and
projecting a projection image having the at least one target picture by the projection device.

12. The control method of the projection device according to claim 11, wherein the step of determining the target theme corresponding to the surrounding environment according to the sensing result further comprises:
determining a target style corresponding to the surrounding environment by the processor according to the sensing result; and
searching the target picture database by the processor according to the target theme and the target style.

13. The control method of the projection device according to claim 11, wherein after generating the at least one target picture, the control method further comprises:
storing the at least one target picture by the processor.

14. The control method of the projection device according to claim 11, wherein after the step of determining the target theme corresponding to the surrounding environment, the control method further comprises:
generating a prompt by the processor according to the target theme;
wherein the step of selecting the at least one target picture from the target picture database comprises:
selecting the at least one target picture by the processor according to the prompt; and
wherein the step of generating the at least one target picture according to the target theme comprises:
generating the at least one target picture by the processor according to the prompt.

15. The control method of the projection device according to claim 11, wherein the environment sensing module comprises a sound receiving device, wherein the step of sensing the surrounding environment of the projection device to obtain the sensing result comprises:
receiving sounds of the surrounding environment by the sound receiving device to generate sound data, wherein the sensing result comprises the sound data;
wherein the step of determining the target theme corresponding to the surrounding environment according to the sensing result comprises:
analyzing the sound data by the processor to determine at least one sound source type corresponding to the sound data, and determining the target theme corresponding to the surrounding environment according to the at least one sound source type.

16. The control method of the projection device according to claim 15, wherein the sound data comprises a user's voice instruction, wherein the step of determining the target theme corresponding to the surrounding environment according to the sensing result comprises:
determining the target theme corresponding to the at least one target image by the processor according to the user's voice instruction.

17. The control method of the projection device according to claim 11, wherein the environment sensing module comprises an image capturing device, wherein the step of sensing the surrounding environment of the projection device to obtain the sensing result comprises:
capturing the surrounding environment by the image capturing device to generate image data, wherein the sensing result comprises the image data;
wherein the step of determining the target theme corresponding to the surrounding environment according to the sensing result comprises:
identifying an object in the image data by the processor, and determining the target theme corresponding to the surrounding environment according to the object.

18. The control method of the projection device according to claim 11, further comprising:
executing a system setting of the projection device and setting the at least one target picture as at least one of a desktop, a standby screen, and an icon of an application of the projection device by the processor.

19. The control method of the projection device according to claim 11, wherein the projection device further comprises an input/output unit, and the control method further comprises:
in response to receiving a user evaluation input via the input/output unit, recording the user evaluation by the processor; and
generating a prompt of the at least one target picture according to the user evaluation.

20. The control method of the projection device according to claim 19, wherein the projection device further comprises a personalized database, the personalized database comprises at least one evaluated picture, the at least one evaluated picture is the at least one target picture with the user evaluation, and the control method further comprises:
identifying at least one of a characteristic parameter and the prompt of the evaluated picture by the processor;
wherein the step of selecting the at least one target picture from the target picture database comprises:
selecting the at least one target picture from the target picture database according to at least one of the characteristic parameter and the prompt; and
wherein the step of generating the at least one target picture according to the target theme comprises:
generating the at least one target picture according to at least one of the characteristic parameter and the prompt.

21. A projection system, comprising an environment sensing device, a projection device, a plurality of picture databases, and an artificial intelligence model, wherein
the environment sensing device is configured to sense a surrounding environment of the projection device to obtain a sensing result,
the artificial intelligence model is coupled to the environment sensing device and the plurality of picture databases, and the artificial intelligence model is configured to determine a target theme corresponding to the surrounding environment according to the sensing result, and search a target picture database that matches the target theme from the plurality of picture databases,
wherein the artificial intelligence model selects at least one target picture from the target picture database in response to searching out the target picture database from the plurality of picture databases,
wherein the artificial intelligence model generates the at least one target picture according to the target theme in response to not searching out the target picture database from the plurality of picture databases; and
wherein the projection device is coupled to the artificial intelligence model, and the projection device is configured to project a projection image having the at least one target picture.

22. The projection system according to claim 21, wherein the artificial intelligence model is disposed in the projection device or a cloud server.

23. The projection system according to claim 21, wherein the plurality of picture databases are disposed in the projection device or a cloud server.
